(19) United States
(12) Patent Application Publication
(10) Pub. No.: US 2007/0247015 A1
(43) Pub. Date: Oct. 25, 2007

(54) ROTOR HAVING LOBED BORE AND METHOD OF ASSEMBLING SAME

(75) Inventor: Stephen Dellinger, Houston, OH (US)

Correspondence Address: MICHAEL BEST & FRIEDRICH LLP, 100 E WISCONSIN AVENUE, Suite 3300, MILWAUKEE, WI, 53202, US

(73) Assignee: A. O. SMITH CORPORATION, Milwaukee, WI (US)

(21) Appl. No.: 11/737,246

(22) Filed: Apr. 19, 2007

Related U.S. Application Data
(60) Provisional application No. 60/794,683, filed on Apr. 25, 2006.

(51) Int. Cl. H02K 1/00; H02K 17/00; H02K 19/14

(52) U.S. Cl. 310/217; 310/261; 310/216; 310/211

(57) ABSTRACT

A rotor for a motor includes a plurality of laminations. Each lamination includes a central opening having an outer surface. The outer surface is defined by a continuous non-circular curve. A shaft includes a cylindrical portion configured to engage the outer surface. The cylindrical portion is sized to define an interference fit between the cylindrical portion and at least a portion of the outer surface.

### RELATED APPLICATION DATA

This application claims benefit under 35 U.S.C. Section 119(e) of co-pending U.S. Provisional Application No. 60/794,683, filed Apr. 25, 2006, which is fully incorporated herein by reference.

### BACKGROUND

The present invention relates to a rotor for an electric machine. More particularly, the invention relates to an electric machine that includes a rotor having a rotor core that includes a non-circular central bore.

Electric machines such as generators and motors generally include a rotor disposed at least partially within a stator. The stator and rotor include magnets or energized coils that produce magnetic fields. The magnetic fields interact to produce the desired rotation (i.e., speed and direction) of the rotor.

Many rotors are produced by stacking a plurality of laminations to define a rotor core and then placing the rotor core onto a shaft. Magnets are then attached to the laminations, coils are wound onto the laminations, or bars are inserted into the laminations to complete the rotor. Generally, each lamination includes a central bore that cooperates with the shaft to define an interference or shrink fit. The interference must be large enough to assure that the laminations will not spin with respect to the shaft. To accomplish this, a large interference fit is generally employed. Typically, the interference fit is such that the laminations or core cannot be forced over the shaft without differential heating of the shaft and core. The differential heating causes a temporary reduction in the interference, thereby reducing the force required to attach the core to the shaft. However, differential heating can be time consuming and costly. In addition, the additional heating step increases the likelihood of errors and thus increases the scrap rate during production.

### SUMMARY

The invention provides a rotor for a motor that includes laminations and can be easily and accurately coupled to a motor shaft. The laminations include a lobed central bore that allows for greater interference between each lamination and the shaft. The lobed surface reduces the contact area between the shaft and each lamination such that a slight increase in the interference between the shaft and the central aperture produces a much smaller increase in the force required for assembly. Thus, the invention allows the shaft to be cold pressed into the rotor core with a reduced likelihood of damage or slippage between the rotor core and the shaft during motor operation.

In one construction, the invention provides a rotor for a motor. The rotor includes a plurality of laminations. Each lamination includes a central opening having an outer surface. The outer surface is defined by a continuous non-circular curve. A shaft includes a cylindrical portion configured to engage the outer surface. The cylindrical portion is sized to define an interference fit between the cylindrical portion and at least a portion of the outer surface.

In another construction, the invention provides a rotor for a motor. The rotor includes a plurality of laminations. Each lamination includes a central opening having an outer surface. The outer surface is defined by a continuous sinusoidal curve that defines a first quantity of peaks. A shaft includes a cylindrical portion configured to engage the first quantity of peaks. The cylindrical portion is sized to define an interference fit between the cylindrical portion and the first quantity of peaks.

In yet another construction, the invention provides a rotor for a motor. The rotor includes a shaft having a cylindrical portion and defining a rotational axis. A first lamination includes a central opening defined by a first continuous non-circular curve that defines a first quantity of peaks. The first lamination is coupled to the shaft. A second quantity of interlock members is formed as part of the first lamination. The second quantity is different from the first quantity. A second lamination includes a central opening defined by a second continuous non-circular curve that defines a third quantity of peaks. The third quantity is equal to the first quantity. A fourth quantity of interlock members is formed as part of the second lamination. The fourth quantity is equal to the second quantity. The second lamination is coupled to the first lamination and the shaft such that each of the second quantity of interlock members is aligned with one of the fourth quantity of interlock members along the rotational axis, and none of the first quantity of peaks is aligned with one of the third quantity of peaks.

### BRIEF DESCRIPTION OF THE DRAWINGS

FIG. 1 is a side schematic view of a motor including a rotor;

FIG. 2 is a perspective view of the rotor of FIG. 1 including a core;

FIG. 3 is a front view of a lamination suitable for use in assembling the core of FIG. 2;

FIG. 3a is an enlarged view of a slot of the lamination of FIG. 3; and

FIG. 3b is an enlarged view of a central aperture of the lamination of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

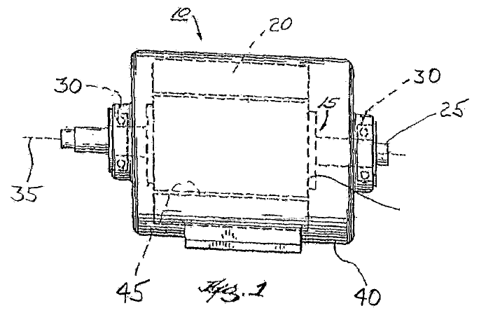

FIG. 1 illustrates a motor 10 that includes a rotor 15 disposed within a stator 20. The rotor 15 includes a shaft 25 that extends axially to provide support points and to provide a convenient shaft power take off point. Generally, two or more bearings 30 engage the rotor shaft 25 and support the rotor 15 such that it rotates about a rotational axis 35. The stator 20 is generally fitted into a frame or housing 40. The stator 20 defines a substantially cylindrical aperture, or bore 45 as it is commonly referred to in the motor art, that is centered on the rotational axis 35. When the rotor 15 is in its operating position relative to the stator 20, a small air gap is established between the rotor and the stator. The air gap allows for relatively free rotation of the rotor 15 within the stator 20.

The motor 10 illustrated in FIG. 1 is an induction motor of the type commonly referred to as a squirrel cage motor. Of course, the invention described herein could be applied to other types of motors, generators, or other electric machines if desired.

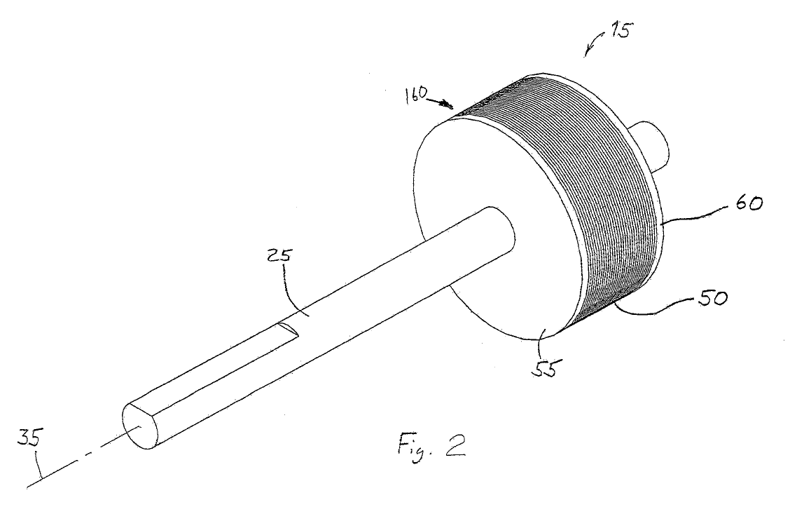

Turning to FIG. 2, one possible rotor 15 suitable for use with the motor 10 of FIG. 1 is illustrated. The rotor 15 includes the shaft 25, a plurality of laminations 50, a first end plate 55, and a second end plate 60. The shaft 25 is substantially cylindrical and includes a constant diameter portion sized to receive the laminations 50. Other shafts may include steps, shoulders, flats, or other features that allow the shaft to interact with other components as may be required.

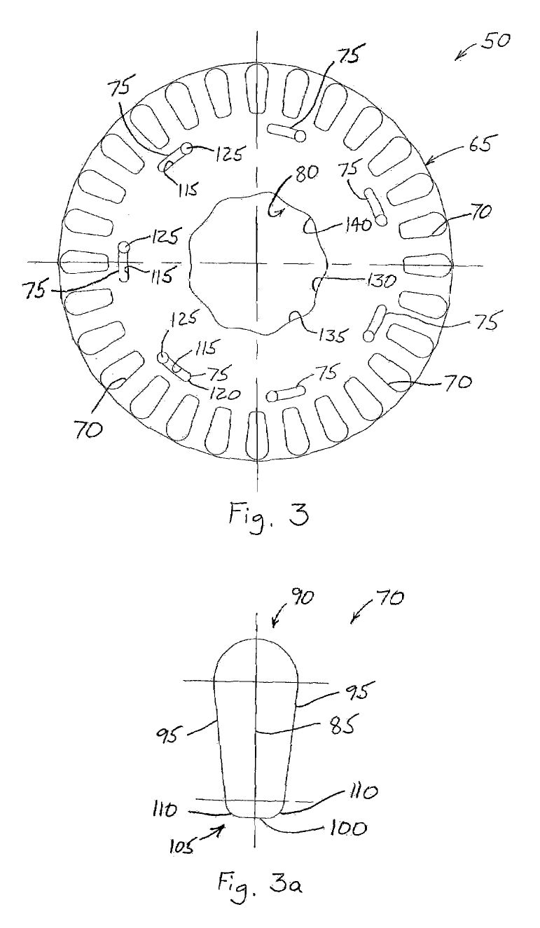

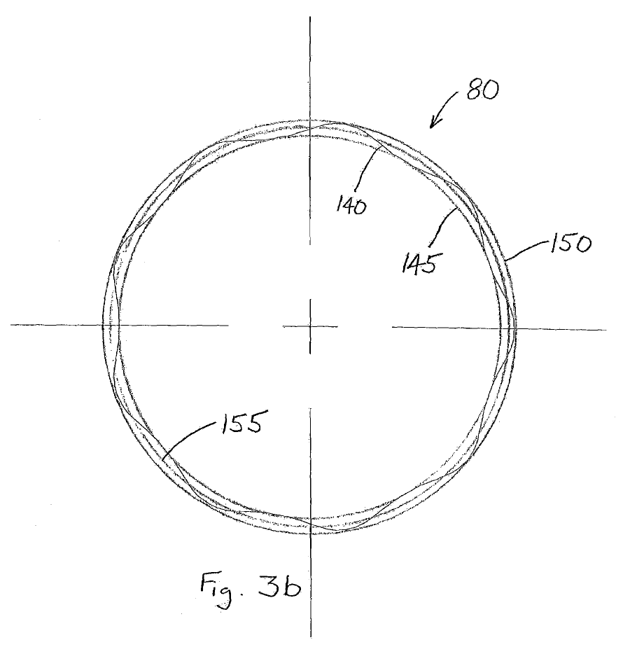

FIG. 3 illustrates one lamination 50 that is suited for use in the construction of the rotor 15 of FIG. 2. The lamination 50 includes a substantially circular outside diameter 65, a plurality of slots 70, a plurality of interlock tabs 75, and a central bore 80. The circular outside diameter 65 is sized to fit within the stator bore 45 and provide the desired air gap between the rotor 15 and the stator 20. The slots 70 are positioned adjacent the outside diameter 65 but are not necessarily open to the outside diameter 65. Thus, the preferred construction includes fully enclosed slots 70, with other constructions employing slots 70 that are open to the outside diameter of the lamination.

Each slot 70 is shaped as illustrated in FIG. 3a. Specifically, the slot 70 includes a longitudinal axis 85 that passes through a first end 90 that is substantially semi-circular. The first end 90 is disposed near the outside diameter 65 of the lamination 50. Two side surfaces 95 extend toward the center of the lamination 50 and toward one another such that the slot opening narrows as the slot 70 approaches the central bore 80 of the lamination 50. At the desired slot length, an end wall 100 extends normal to the longitudinal axis 85 of the lamination 50 to connect the side surfaces 95 and define a second end 105. In preferred constructions, fillets 110 are used at the intersection of the side surfaces 95 and the end wall 100 to reduce the likelihood of cracking during the forming or assembly process. As one of ordinary skill in the art will realize, many other slot shapes could be employed if desired. In addition, various slot shapes could be employed in each lamination 50 if desired. As such, the invention should not be limited to the illustrated slot shape alone.

The slots 70 are arranged around the circumference of the lamination 50 such that each of the longitudinal axes 85 are radial lines that pass through the center of the lamination 50. In addition, in preferred constructions, the slots 70 are equally spaced circumferentially. Thus, the angle between the longitudinal axes 85 of two adjacent slots 70 is equal to 360 divided by the number of slots 70. For example, in the illustrated constructions, 28 slots 70 are employed with each slot 70 being spaced about 12.86 degrees from the adjacent slot 70. Of course other constructions may employ a different number of slots 70 if desired. In some constructions, laminations with no slots are employed. For example, permanent magnet motor rotors do not require slots, but rather position permanent magnets on the outer surface of the laminations. In still other constructions, other slot arrangements or lamination arrangements are employed.

In the illustrated construction, the angle of the side surfaces 95 with respect to the longitudinal axis 85 of the each slot 70 is chosen such that adjacent side surfaces 95 of adjacent laminations 50 are parallel to one another. Thus, the side surfaces 95 of the slots 70 are generally not radial lines.

Each interlock tab 75 includes a substantially oval slot 115 that is disposed radially between the central bore 80 and the slots 70. In the illustrated construction, the interlock tabs 75 are disposed near the slots 70 with other positions also being suitable. One end of the slot terminates in a semi-circle 120, while the other end of the slot 115 terminates at a substantially cylindrical projection 125. In the illustrated construction, each of the projections 125 is on the clockwise most side of the slot 115, with either end of the slot 115 being suitable. The projection 125 extends above the plane of the lamination 50 on one side of the lamination 50 and defines an indentation on the opposite side of the lamination 50. Thus, when the laminations 50 are stacked, the projections 125 of one lamination 50 must at least partially extend into the indentations of the adjacent lamination 50 to achieve the desired close fit of the stack. As one of ordinary skill in the art will realize, other shapes and styles of interlock tabs 75 could be employed if desired.

In the construction of FIG. 3, seven interlock tabs 75 are employed. The interlock tabs 75 are equally radially spaced around the lamination 50. Thus, the angle between any two adjacent interlock tabs 75 is equal to 360 divided by the number of interlock tabs 75. For example, in the illustrated construction, the seven interlock tabs 75 are arranged such that each interlock tab 75 is about 51.43 degrees from the adjacent interlock tabs 75. The number of interlock tabs 75 is preferably chosen such that the number of slots 70 is divisible by the number of interlock tabs 75. This assures that no matter how the laminations 50 are arranged, so long as the interlock tabs 75 are aligned, the slots 70 will be aligned. In other constructions, a different number of interlock tabs 75 is chosen such that the slots 70 are offset slightly as the laminations 50 are stacked. The offset produces a slight but sometimes desirable skew in the slots 70.

The central aperture 80 is sized to receive the shaft 25 to attach the lamination 50 to the shaft 25. The central aperture 80 is defined by a lobed surface 130 that includes a number of equally spaced peaks 135 and valleys 140. The peaks 135 cooperate to define an inner circle 145 that is tangent to each of the peaks 135. Similarly, the valleys 140 cooperate to define an outer circle 150 that is tangent to each of the valleys 140. In the illustrated construction, the lobed surface 130 is defined by a sine wave having a wavelength that is about one-ninth the circumference of a middle circle 155 disposed equidistant from the inner circle 145 and the outer circle 150. The wavelength is chosen such that the surface 130 defines the desired number of peaks 135 and valleys 140. Thus, a wavelength that is greater or less than one-ninth the circumference of the middle circle 155 is also possible.

The amplitude of the sine wave is such that the inner circle 145 defines a desired interference with the shaft 25. For example, if an interference fit of 0.1 percent of the shaft diameter is desired, the inner circle is 0.1 percent smaller than the outside diameter of the shaft 25. As with the wavelength, a large range of amplitudes may be employed as required for the particular application.

In the illustrated construction, the lobed surface 130 includes nine peaks 135 and nine valleys 140. The use of nine peaks 135 and nine valleys 140 assures that as the laminations 50 are stacked, the peaks 135 will not align with one another if adjacent laminations 50 are rotated. The misalignment of the peaks 135 assures that the shaft 25 contacts the desired amount of the lamination 50 as the shaft 25 is inserted and also improves the concentricity of the shaft 25 and the laminations 50. In other constructions, other quantities of peaks 135 and valleys 140 could be employed if desired.

The orientation of the peaks 135 of adjacent laminations 50 can be used in conjunction with the height of the peaks 135 to control the amount of force required to position the laminations 50 on the shaft 25. For example, if all of the laminations 50 are arranged such that the peaks 135 align, less total force will be required to install the laminations 50 as the peaks 135 wear grooves into the shaft 25. The grooves, while very shallow, reduce the force required for subsequent laminations 50. In another example, the laminations 50 are grouped in groups of two or more laminations 50 in which the peaks 135 align. Again, less force will be required to position laminations 50 having aligned peaks 135. In constructions in which every lamination 50 is rotated slightly, the force required for installation of the laminations 50 is not greatly reduced for subsequent laminations 50. As such, the orientation of the laminations 50 should not be limited to only those described herein.

To manufacture a rotor 15, one first manufactures a plurality of laminations 50. In preferred constructions, the laminations 50 are stamped from electric grade steel. One punching operation generally forms all of the features of the lamination 50. In addition, in motors 10 that employ stators 20 with stator laminations, the rotor laminations 50 and stator laminations are often formed simultaneously to reduce waste.

The rotor laminations 50 are next stacked on top of one another to define a rotor core 160 having a desired core length. In preferred constructions, each lamination 50 is rotated slightly during stacking. For example, in the illustrated construction, the second lamination 50 is rotated about 51.43 degrees with respect to the previous lamination 50 such that the interlock tabs 75 still align. The rotation of the laminations 50 is not apparent based on the slots 70 or the interlock tabs 75 as these features remain aligned. However, the rotation of the laminations 50 assures that the peaks 135 and valleys 140 of adjacent laminations 50 are not aligned.

Once the core 160 is stacked, conductive bars 165 can be positioned or formed (e.g., molded, cast, etc.) within the slots 70. For example, one construction employs die cast aluminum bars 165 cast into the laminations 50. The end plates 55, 60 are then positioned to electrically connect the bars 165 and cover the laminations 50. In preferred constructions, the end plates 55, 60 are smooth to reduce windage losses.

Once the core 160 is complete, the shaft 25 can be inserted into the central aperture 80. In cores 160 with a traditional circular central aperture, the interference had to be maintained within a very narrow band to allow for the assembly, and to assure that the core would not spin with respect to the shaft 25. The need for the accurate interference was due to the fact that a slight increase in interference produced additional forces around the entire circumference of the shaft 25. The present invention allows for a wider tolerance band as the same slight increase in interference produces a much smaller force, as only the peaks 135 are in contact with the shaft 25. This allows the shaft 25 to be cold pressed (i.e., no differential heating between the shaft 25 and the core 160) into the core, while still assuring adequate interference between the shaft 25 and the core 160. With the shaft 25 inserted, the rotor 15 is complete and can be positioned within the stator 20 to complete the assembly of the motor 10.

Thus, the invention provides, among other things, a new and useful rotor 15 for a motor 10. More particularly, the invention provides a new and useful rotor 15 that includes laminations that can be easily and accurately assembled using a cold press process.

What is claimed is:

1. A rotor for a motor, the rotor comprising:
a plurality of laminations, each lamination including a central opening having an outer surface, the outer surface defined by a continuous non-circular curve; and
a shaft including a cylindrical portion configured to engage the outer surface, the cylindrical portion sized to define an interference fit between the cylindrical portion and at least a portion of the outer surface.

2. The rotor of claim 1, wherein the non-circular curve includes a substantially sinusoidal curve centered on a circular path.

3. The rotor of claim 1, wherein the non-circular curve of each of the laminations defines a first quantity of peaks, and wherein each lamination includes a second quantity of interlock members, the second quantity different from the first quantity.

4. The rotor of claim 3, wherein a first lamination of the plurality of laminations is coupled to a second lamination of the plurality of laminations such that each interlock member of the first lamination engages one of the interlock members of the second lamination and none of the peaks of the first lamination align with the peaks of the second lamination in a direction along a long axis of the shaft.

5. The rotor of claim 3, wherein the first quantity is at least nine.

6. The rotor of claim 3, wherein each lamination includes a third quantity of slots, the third quantity being different from the first quantity and an integer multiple of the second quantity.

7. The rotor of claim 6, wherein each of the slots includes two substantially planar surfaces arranged such that the surfaces are substantially parallel.

8. The rotor of claim 7, wherein each of the slots includes two curved surfaces, the two curved surfaces and the two planar surfaces cooperating to completely enclose the slot.

9. A rotor for a motor, the rotor comprising:
a plurality of laminations, each lamination including a central opening having an outer surface, the outer surface defined by a continuous sinusoidal curve that defines a first quantity of peaks; and
a shaft including a cylindrical portion configured to engage the first quantity of peaks, the cylindrical portion sized to define an interference fit between the cylindrical portion and the first quantity of peaks.

10. The rotor of claim 9, wherein the sinusoidal curve is centered on a circular path.

11. The rotor of claim 9, wherein each lamination includes a second quantity of interlock members, the second quantity different from the first quantity.

12. The rotor of claim 11, wherein a first lamination of the plurality of laminations is coupled to a second lamination of the plurality of laminations such that each interlock member of the first lamination engages one of the interlock members of the second lamination and none of the peaks of the first lamination align with the peaks of the second lamination in a direction along a long axis of the shaft.

13. The rotor of claim 11, wherein the first quantity is at least nine.

14. The rotor of claim 11, wherein each lamination includes a third quantity of slots, the third quantity being different from the first quantity and an integer multiple of the second quantity.

15. The rotor of claim 14, wherein each of the slots includes two substantially planar surfaces arranged such that the surfaces are substantially parallel.

16. The rotor of claim 15, wherein each of the slots includes two curved surfaces, the two curved surfaces and the two planar surfaces cooperating to completely enclose the slot.

17. A rotor for a motor, the rotor comprising:
a shaft including a cylindrical portion and defining a rotational axis;
a first lamination including a central opening defined by a first continuous non-circular curve that defines a first quantity of peaks, the first lamination coupled to the shaft;
a second quantity of interlock members formed as part of the first lamination, the second quantity being different from the first quantity;
a second lamination including a central opening defined by a second continuous non-circular curve that defines a third quantity of peaks, the third quantity being equal to the first quantity; and
a fourth quantity of interlock members formed as part of the second lamination, the fourth quantity being equal to the second quantity, the second lamination coupled to the first lamination and the shaft such that each of the second quantity of interlock members is aligned with one of the fourth quantity of interlock members along the rotational axis, and none of the first quantity of peaks is aligned with one of the third quantity of peaks.

18. The rotor of claim 17, wherein the first continuous non-circular curve includes a first substantially sinusoidal curve centered on a first circular path, and the second continuous non-circular curve includes a second substantially sinusoidal curve centered on a second circular path.

19. The rotor of claim 17, wherein the first lamination and the second lamination includes a fifth quantity of slots, the fifth quantity being different from the first quantity and the third quantity, and the fifth quantity being an integer multiple of the second quantity and the fourth quantity.

20. The rotor of claim 19, wherein each of the slots includes two substantially planar surfaces arranged such that the surfaces are substantially parallel.

21. The rotor of claim 20, wherein each of the slots includes two curved surfaces, the two curved surfaces and the two planar surfaces cooperating to completely enclose the slot.

22. The rotor of claim 17, wherein the first quantity is nine and the second quantity is seven.
